(19) United States
(12) Patent Application Publication
(10) Pub. No.: US 2013/0038694 A1
(43) Pub. Date: Feb. 14, 2013

(54) METHOD FOR MOVING OBJECT DETECTION USING AN IMAGE SENSOR AND STRUCTURED LIGHT

(71) Applicants: Sanjay Nichani, San Diego, CA (US); Chethan Reddy, San Diego, CA (US)

(72) Inventors: Sanjay Nichani, San Diego, CA (US); Chethan Reddy, San Diego, CA (US)

(21) Appl. No.: 13/644,000

(22) PCT Filed: Apr. 27, 2011
(86) PCT No.: PCT/US11/34053

§ 371 Date: Oct. 26, 2012

(30) Foreign Application Priority Data
Apr. 27, 2010 (US) 61328518

(51) Int. Cl. H04N 13/02

(52) U.S. Cl. 348/46; 348/E13.074

(57) ABSTRACT

A method for detecting moving objects including people. Enhanced monitoring, safety and security is provided through the use of a monocular camera and a structured light source, by trajectory computation, velocity computation, or counting of people and other objects passing through a laser plane arranged perpendicular to the ground, and which can be setup anywhere near a portal, a hallway or other open area. Enhanced security is provided for portals such as revolving doors, mantraps, swing doors, sliding doors, etc., using the monocular camera and structured light source to detect and, optionally, prevent access violations such as “piggybacking” and “tailgating”.

### CROSS-REFERENCE TO RELATED APPLICATIONS

This application claims the benefit of U.S. provisional patent application 61/328,518 filed Apr. 27, 2010, the disclosure of which is incorporated herein by reference.

### STATEMENT REGARDING FEDERALLY SPONSORED RESEARCH

Not Applicable.

### BACKGROUND OF THE INVENTION

The movement of people or objects through various spaces, passageways and portals is monitored or controlled for any number of purposes including safety, security or traffic monitoring. Such monitoring and control are performed most efficiently when it is done automatically and with little or no human intervention.

Automated and manual security portals provide controlled access to restricted areas and are used for keeping track of when (and which) individuals are inside or outside a facility. These security portals are usually equipped with card access systems, biometric access systems or other systems for validating a person's authorization to enter restricted areas or recording their presence/absence inside a facility. A typical security issue associated with most access controlled portal security systems is that when one person obtains valid access; an unauthorized person may bypass the validation security by “piggybacking” or “tailgating”. Piggybacking occurs when an authorized person knowingly or unknowingly allows access to another person traveling in the same direction. Tailgating occurs when an authorized person knowingly or unknowingly provides unauthorized access through a portal to another person traveling in the opposite direction.

Applicants have developed an invention called APATS-R (Anti-Piggy Backing and Tailgating Solution for Revolving Doors) which incorporates a camera and structured light laser inside a mechanical enclosure called a camera-laser head. This is connected to a processor such as a PC which is powered by custom machine vision algorithms. APATS-R is designed to detect and/or prevent piggybacking and tailgating.

Enhanced monitoring, safety and security is provided by the general invention through the use of a monocular camera and a structured light source and employs trajectory computation, velocity computation, or counting of people and other objects passing through a laser plane oriented perpendicular to the ground. The invention can be setup anywhere near a portal, a hallway or other open area. APATS-R is used with portals such as revolving doors, mantraps, swing doors, sliding doors etc.

Various prior art sensors and systems are known and used for automatic object detection systems. These include, for example, photo voltaic sensors which detect objects interrupting a beam of visible or ultraviolet (UV) light. Mechanical switches and load cells detect objects through direct or indirect contact or by detecting an object's weight. Thermal sensors detect objects radiating heat; and, electromagnetic sensors detect objects such as metal objects that alter electromagnetic fields. The sensors typically send signals to logic circuits which control mechanical actuators, record the object's presence, and/or alert an operator based on the presence/absence of an object. But, such systems are not well suited for certain security systems because they are easily circumvented; only detect a certain class of objects moving through a narrowly constrained space; and cannot directly determine an object's direction or velocity. The sensors also often have problems maintaining uniform sensitivity through a monitored space, over time, and are be prohibitively expensive.

Various camera based systems are also known for use in object detection and control in security or safety applications. Camera based systems have the additional advantage or providing an image of a monitored space which can be stored for later analysis. Such systems typically use an imaging sensor. Monocular camera based systems are typically based on frame differencing or background subtraction techniques (where background is modeled) and, as such, have issues such as being triggered due to highlights and shadows. In addition, the techniques employed with such systems are tedious to work with and often do not work when there is a moving background such as motion of the portal itself (i.e., a swinging door). Further, when an extremely wide hallway or portal needs protecting, an array of these sensors (being monocular) often have difficulties due to overlaps in their fields of view and do not generate accurate information.

Various prior art sensors/systems such as those listed in the attached Appendix A to this application reflect these and other problems.

### BRIEF SUMMARY OF THE INVENTION

A factory calibrated camera and laser combination system is used to compute 3-dimensional (3D) coordinates of laser points that are visible in a field of view. During installation, a plane of known height parallel the ground is calibrated relative to a camera. This is referred to as a world plane or coordinate system. Only those points are considered interesting that fall within a target volume relative to this plane. This volume may be static; e.g., all points which are 5 inches above the ground in a hallway, or the volume may be dynamically created, e.g. points inside the two wings of a moving revolving door. These points of interest are then used to create a line or row in a depth (also called height) image. This image is concatenated over time in the form of consecutive rows. Optionally, and in addition, a trajectory is computed at these points of interest to create a line or row in a velocity image which is also concatenated over time in the form of consecutive rows. After the depth and/or velocity images have been accumulated, either for a pre-determined time, or after the occurrences of an event (a door closing or a door reaching a pre-determined position or range of positions), the image(s) is analyzed. The depth map topography is analyzed for objects (a process called “segmentation”). The preferred algorithm used for analyzing a depth map for images is called “watershed segmentation”. Once objects have been segmented, information about each object is gathered. This includes its area, shape, position, volume, and trajectory (from the velocity image). The information is then used to generate detection events such as a count, or an audible alarm, or a signal to an event camera or a digital video recorder (DVR), or to a controller that drives mechanical actuators to prevent a breach occurring.

### BRIEF DESCRIPTION OF THE SEVERAL VIEWS OF THE DRAWINGS

The foregoing and other objects, features and advantages of the invention will be apparent from the following more particular description of the preferred embodiments of the invention, as illustrated in the accompanying drawings in which like reference characters refer to the same parts throughout the different views. The drawings are not necessarily drawn to scale, emphasis being placed upon illustrating the principles of the invention.

FIG. 1. System diagram for a 2-Way revolving door. This is a block diagram of the system for the preferred embodiment for a revolving door (called APATS-R).

FIG. 2a. Mini-PC, This is the processor that runs the software and is used to process the acquired images and generate the various events.

FIG. 2b. Camera-laser head, this is a box that holds both the camera and the laser.

FIG. 2c. I/O board, this is a picture of the input-output interface that takes events generated from the software and issues them to the door controller or vice-versa.

FIG. 2d. Wireless router, this is attached to the mini-PC to allow for wireless setup of the software running on the mini-PC via a lap-top.

FIG. 2e. APATS_CMD software on a compact disc (CD), this is the software that is installed on a lap-top or external-PC to allow the setup of the software on the mini-PC.

FIG. 2f: System components needed for a 1-way and a 2-way revolving door. For a 1-way door, there is just concern for anti-piggybacking and anti-tailgating for people entering into a secure building while for 2-way both entry and exit pathways are protected.

FIG. 3: Mounting of the laser-camera head on a revolving door.

FIG. 4: This is a block diagram of the software algorithm main loop for revolving door system (called APATS wrapper). This is the top-level code that calls various computer vision tools (called processors) and implements the state machine to interface to the acquisition engine and the revolving door.

FIG. 5. Camera-laser head design, this is the geometry associated with the camera and the laser.

FIG. 6. This is the block diagram of the computer vision tool or algorithm called APATS processor that is used to generate the depth map and the velocity map.

FIG. 7. A diagram of the world calibration, world coordinate system and door coordinate system.

FIG. 8. This is a picture of the location of the laser 1-Dimensional (1D) edge detectors. This is used by the APATS-processor to generate the depth map.

FIG. 9: Flowchart Showing APATS event generation. This logic is used to generate an event from the generated depth and velocity maps.

FIG. 10: A flowchart of the camera blocked algorithm. This logic is used to detect if a camera is intentionally blocked, important for security applications.

FIG. 11: Laser 1D edge detector. This figure illustrates the basic operation of a 1D edge detector.

FIG. 12. Depth map for a single person walking through a revolving door (with APATS-R).

FIG. 13. Depth map for two people walking through a revolving door (with APATS-R).

FIG. 14. A flow chart of the laser blocked algorithm. This logic is used to detect if a laser is intentionally blocked (or if it burns out), important for security application.

Corresponding reference numerals indicate corresponding parts throughout the several figures of the drawings.

### DESCRIPTION OF THE PREFERRED EMBODIMENT

A description of the preferred embodiments of the invention is described below:

The present invention is directed at systems and methods of providing enhanced portal security through the use of a camera and a structured light. A particular embodiment is APATS-R that detects and optionally prevents access violations, such as piggybacking and tailgating. APATS-R generates a three-dimensional image of the portal scene from a camera and a structured light source, and further detects and tracks people moving through the resulting target volume.

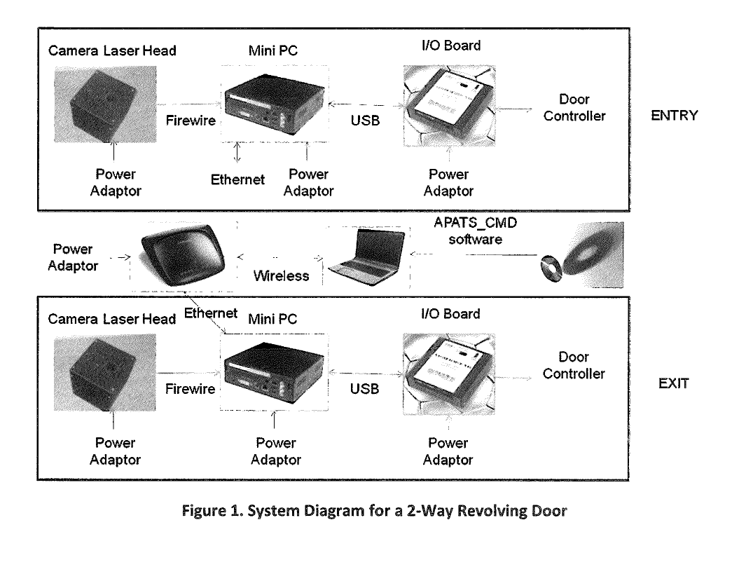

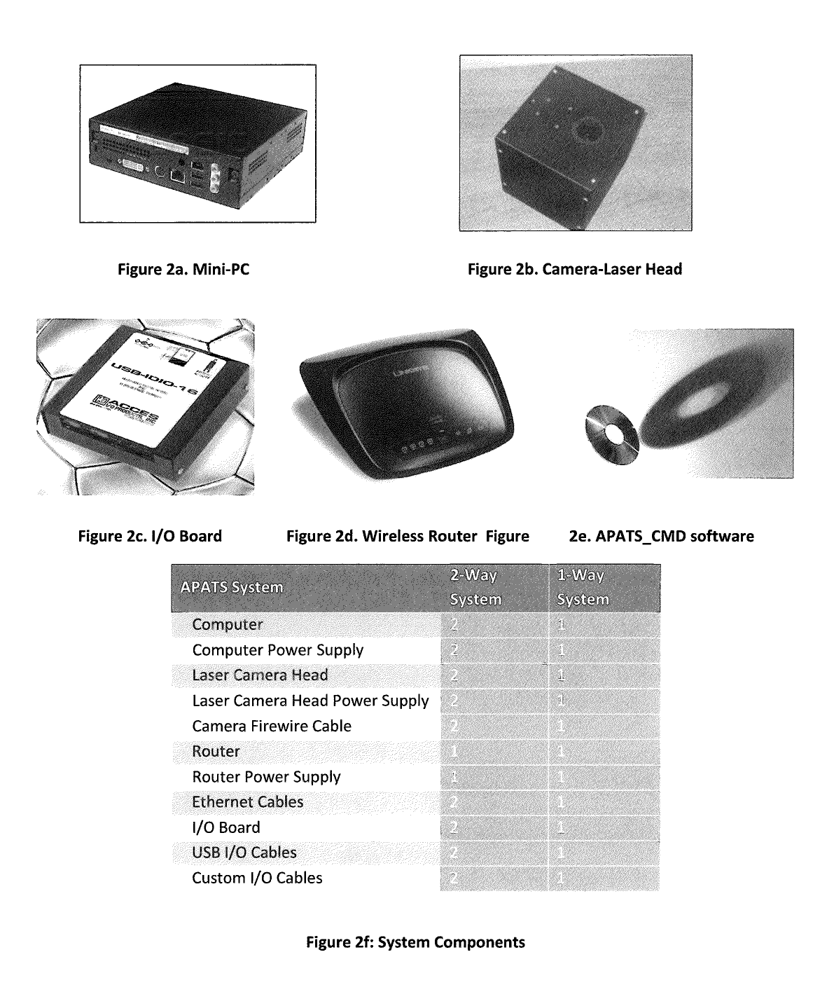

The APATS-R system consists of the following components as shown in FIG. 1 and FIG. 2.
Small form factor mini-PC with mounting brackets
Camera-laser head mounted over-head
I/O interface box from the PC to door controller (DC)
Router for wireless access to the PC
Setup software APATS_CMD for installation on a setup laptop
Firewire cable to connect camera-laser head to the mini-PC.
Power adapter for powering camera-laser head
Power adapter for the router
Power adapter for the mini-PC
Ethernet cable to connect the PC to the router
USB cable to connect the mini-PC to the IO interface box
I/O cables that are pre-attached to the IO interface box and need to be connected to the door controller (DC).

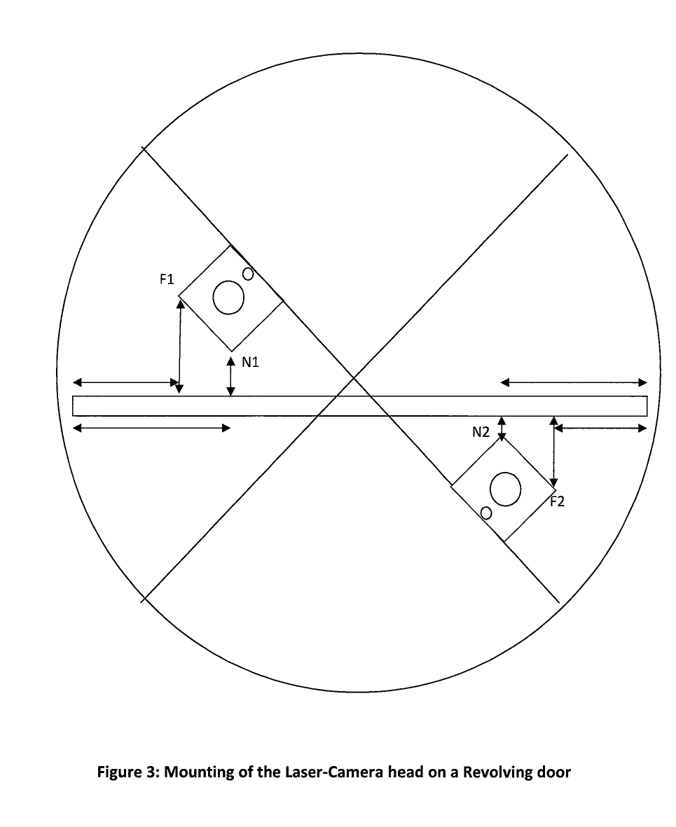

The camera-laser heads are mounted on the entry and exit sides (see FIG. 3) with the laser and the camera pointing downwardly. The unit must be level, and as close to the bottom of the ceiling cut-out as possible, without the door panels brushing the camera's lenses. The side face adjacent to the laser, lines up with the Entry and Exit positions of the door. This creates a laser plane at the very start of the compartment, i.e., the area where a person(s) has to pass through. The distances of the bottom corners of the opposite side face are given relative to the center beam for a 40″ radius revolving door in the following table.

| | |
|---|---|
| N1 Horizontal | 23.625″ |
| N1 Vertical | 12″ |
| F1 Horizontal | 19.625″ |
| F1 Vertical | 15.75″ |
| N2 Horizontal | 23.4375″ |
| N2 Vertical | 2.25″ |
| F2 Horizontal | 19.4375″ |
| F2 Vertical | 6.25″ |

The following are the connections to APATS-R:
The PC, I/O interface box, router should be located in the ceiling of the revolving door. For a 2-way system, there will be 2 PCs and 2 I/O boxes, 1 for each side, entry and exit.
Connect a power adapter to each laser head
Connect the firewire cable between each head and the corresponding computer using the firewire port.
Power the PC(s) with the supplied adapter.
Power the router with the supplied adapter.
Connect the Ethernet cable between the PC Ethernet port and the router port 1. For a 2-way system connect the Ethernet port of the 2^{nd} PC to port 2 of the router.
Connect the I/O cables coming from the I/O interface box to the door controller using its reference manual.
Connect the supplied USB cable(s) to connect the I/O interface box to the PC(s).

Alternate Embodiment—Swing Door/Sliding Door

The camera-laser head can be mounted outside the header, on top of a swing door or a sliding door (with the mini-PC in the header), such that the laser-plane is on or parallel to the door threshold. This embodiment can be used to count people going through the door-way which can then be used for generating events such as anti-piggybacking and anti-tailgating similar to the revolving door or simply for people counting to generate statistics.

Alternate Embodiment—Wrong-Way Detection/People Counting in a Hallway

The camera-laser head can be mounted either on a ceiling or on a custom header either hanging from a ceiling or supported by legs (with the mini-PC in the header or in the ceiling), such that the laser-plane is perpendicular to the ground. This can be used for people counting to generate statistics or alternatively object trajectories could be used for wrong-way detection for areas such as airport exits.

Alternate Embodiment—Mantraps/Portals

The camera-laser head can be mounted inside the ceiling (with the mini-PC processor in the ceiling) just at the entrance of the mantrap, such that the laser-plane is perpendicular to the floor and parallel to the door threshold. This can be used to count people going through the entrance which, in turn, may generate an event such as too-many people (depending on how many people are allowed in the portal at any given time). This may need to be coupled with another camera-laser head at the exit to ensure that people do not remain in the compartment. Alternatively, one may use presence/absence sensors to determine if the compartment is empty.

Alternate Embodiment—Embedded System Instead of a Separate Mini-PC

In all the above embodiments we show a separate external mini-PC used as a processor, however, one can use a single board computer or an embedded system (also possibly with an integrated camera) so the sensor is all self-contained within the camera-head laser enclosure.

Structured Light

APATS-R uses a line laser at 785 nm, with a fan angle of 90°. The intensity of the laser is designed to be uniform along the line. The line thickness is, for example, 1 mm, so that it is resolvable at the floor when imaged by a camera, i.e., when both the laser and the camera are mounted from a ceiling. The laser intensity is maximized, but the classification is kept at 1M for eye safety. This near-infrared laser line is not visible to the naked eye.

Camera

Any standard global shutter monochrome machine vision camera can be used for the system, which allows for software (or manual) controlled shutter and gain. This is an integral part of the run-time algorithm. The camera used is a CMOS camera from Point Grey Research and is referred to as a Firefly-MV. It is a monochrome camera with a resolution of 640×480.

Filter

The filter from the IR camera is removed so the near-infrared laser line is visible to the camera. However, to further enhance visibility of the laser relative to its background; a bandpass filter is installed that passes a laser wavelength of 785 nm. In the APATS-R system, a BP800-R14 from Midwest optical filter is used. This filter is a single substrate, hard-coated filter and is a very broad absorptive bandpass filter that cuts on sharply at 725 nm (50% point), peaks at about 800 nm, and cuts off very gradually over a range from 900 to 1200 nm. One could alternatively use a laser with another wavelength such as 840 nm and a matching band-pass filter centered at that value. The 725 nm cut on BP800-R14 filter could be optionally coated with a shortpass coating to cut off larger wavelengths than 780 nm. Other options would be to use more aggressive or narrow bandpass filters that are centered on 780 nm.

APATS-R Camera-Laser Head Design

The laser and the camera are mounted in a mechanical enclosure called a camera-laser head. The design of this head is dictated by two important parameters, a baseline which is the distance between the camera's principal point and the laser. This distance is preferably about 3.125″. The second parameter is the vergence angle θ between the camera and the laser and is typically about 5°. These values work well for detecting people with a laser-head mounted from typically 7-10 ft. The larger the baseline and the vergence angle, the greater is the accuracy of the depth measurements; but, occlusion also increases, which means that parts of the object lit by the laser are not visible to the camera. Accordingly, one has to strike a balance between the two parameters. Once a camera-laser head is manufactured, it is subjected to a series of calibrations as described in the next section.

Camera Calibration

The camera's calibration techniques are described in computer vision textbooks and prior-art literature. See, for example, references [6] and [7] in Appendix A. For the APATS-R product, the inventors have used the camera calibration toolbox from OpenCV, an open source computer vision library, described in reference [5].

The remainder of this description is from the OpenCV reference manual. The calibration functions in OpenCV use a “pinhole” camera model. That is, a scene view is formed by projecting 3D points into the image plane using a perspective transformation.

sm′=A[R|t]M′

or

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ]$$

Here (X, Y, Z) are the coordinates of a 3D point in a coordinate space, and (u,v) are the coordinates of the projection point in pixels; A is a camera matrix, or a matrix of intrinsic parameters; (cx, cy) is a principal point (and is usually at the image's center); and, fx, fy are focal lengths expressed in pixel-related units. Thus, if an image obtained from the camera is scaled by some factor, all of these parameters should be scaled (multiplied/divided, respectively) by the same factor. The matrix of intrinsic parameters does not depend on the scene viewed and, once estimated, can be re-used (as long as the focal length is fixed (in case of a zoom lens)). The joint rotation-translation matrix [R|t] is called a matrix of extrinsic parameters and is used to describe the camera's motion around a static scene, or vice versa, rigid motion of an object in front of still camera. That is, [R|t] translates coordinates of a point (X, Y, Z) to some coordinate system, fixed with respect to the camera. The transformation above is equivalent to the following (when z≠0):

$$[ \begin{matrix}x \\ y \\ z\end{matrix} ] = R [ \begin{matrix}X \\ Y \\ Z\end{matrix} ] + t$$

$${x}^{′} = x / z$$

$${y}^{′} = y / z$$

$$u = {f}_{x} * {x}^{′} + {c}_{x}$$

$$v = {f}_{y} * {y}^{′} + {c}_{y}$$

Real lenses usually have some distortion, mostly radial distortion and a slight tangential distortion. So, the above model is extended as:

$$[ \begin{matrix}x \\ y \\ z\end{matrix} ] = R [ \begin{matrix}X \\ Y \\ Z\end{matrix} ] + t$$

$${x}^{′} = x / z$$

$${y}^{′} = y / z$$

$${x}^{″} = {x}^{′} ( 1 + {k}_{1} {r}^{2} + {k}_{2} {r}^{4} + {k}_{3} {r}^{6} ) + 2 {p}_{1} {x}^{′} {y}^{′} + {p}_{2} ( {r}^{2} + 2 {x}^{′2} )$$

$${y}^{″} = {y}^{′} ( 1 + {k}_{1} {r}^{2} + {k}_{2} {r}^{4} + {k}_{3} {r}^{6} ) + {p}_{1} ( {r}^{2} + 2 {y}^{′2} ) + 2 {p}_{2} {x}^{′} {y}^{′}$$

$$where$$

$${r}^{2} = {r}^{′2} + {y}^{′2}$$

$$u = {f}_{x} * {x}^{″} + {c}_{x}$$

$$v = {f}_{y} * {y}^{″} + {c}_{y}$$

where k₁, k₂, k₃ are radial distortion coefficients; p₁, p₂ are tangential distortion coefficients. Higher-order coefficients are not considered in OpenCV. In the functions below, the coefficients are passed or returned as a vector

(k₁,k₂,p₁,p₂[,k₃])

That is, if the vector contains 4 elements, it means that k₃=0. The distortion coefficients do not depend on the scene viewed, and thus also belong to the intrinsic camera parameters. Further, they remain the same regardless of the captured image resolution. That is, if, for example, a camera has been calibrated on images of 320×240 resolution, the same distortion coefficients can be used for images of 640×480 resolution from the same camera (while fₓ, f_{y}, cₓ and c_{y} need to be scaled appropriately).

The following function finds the camera intrinsic and extrinsic parameters from several views of a calibration pattern. However, in the case of APATS-R, it is only used to find the intrinsic parameters. A separate step referred to as “World Calibration” and described in the next section is used to find the extrinsic parameters.

CalibrateCamera2 (objectPoints, imagePoints, pointCounts, imageSize, cameraMatrix, distCoeffs, rvecs, tvecs, flags=0)

The function estimates the intrinsic camera parameters and extrinsic parameters for each of the views. The coordinates of 3D object points and their correspondent 2D projections in each view must be specified. This may be achieved by using an object of known geometry with easily detectable feature points. Such an object is called a calibration pattern, and OpenCV has built-in support for, for example, a chessboard as a calibration pattern (see FindChessboardCorners). Initialization of intrinsic parameters is only implemented for planar calibration patterns (i.e., where the z-coordinate of all the object points is 0).

The algorithm does the following:

First, it computes initial intrinsic parameters. Typically, distortion coefficients are initially all set to zero.

The initial camera pose is estimated as if the intrinsic parameters are already known. This is done using FindExtrinsicCameraParams2.

After that is completed, a global Levenberg-Marquardt optimization algorithm is run to minimize the reprojection error. This is the total sum of squared distances between observed feature points imagePoints and projected (using the current estimates for camera parameters and the poses) object points objectPoints; This is done using ProjectPoints2.

ProjectPoints2 (objectPoints, rvec, tvec, cameraMatrix, distCoeffs, imagePoints, dpdrot=NULL, dpdt=NULL, dpdf=NULL, dpdc=NULL, dpddist=NULL)

This function computes projections of 3D points to an image plane given intrinsic and extrinsic camera parameters. Optionally, the function computes jacobians which ware matrices of partial derivatives of image point coordinates (as functions of all the input parameters) with respect to the particular parameters, intrinsic and/or extrinsic. The jacobians are used during the global optimization in CalibrateCamera2, FindExtrinsicCameraParams2. The function itself can also used to compute re-projection error given the current intrinsic and extrinsic parameters.

Undistort

Undistort2 (src, dst, cameraMatrix, distCoeffs)

This function transforms the image to compensate for radial and tangential lens distortion.

The function is a combination of InitUndistortRectifyMap (with unity R) and Remap (with bilinear interpolation). See the former function for details of the transformation being performed. Those pixels in the destination image for which there are no correspondent pixels in the source image, are assigned a 0 (black color) value.

The particular subset of a source image that is visible in the corrected image is regulated by newCameraMatrix. GetOptimalNewCameraMatrix is used to compute the appropriate newCameraMatrix, depending on the requirements of a particular installation.

Camera matrix and distortion parameters are determined using CalibrateCamera2. If the resolution of an image differs from the used during calibration, it will be scaled accordingly, while the distortion coefficients remain the same.

World Calibration

The image is first undistorted using the routine above to compensate for lens distortion and all further calibrations (world and laser) and run-time processing images are assumed to have zero lens distortion. In the case below, distCoeffs is set to NULL.

This calibration can be done in the factory if the sensor can be placed accurately on a revolving door (positioning (tx, ty, tz) and the 3 tilt directions). However, if this cannot be done, a World Calibration step is performed in the field.

FindExtrinsicCameraParams2 (objectPoints, imagePoints, cameraMatrix, distCoeffs, rvec, tvec, useExtrinsicGuess=0)

This function estimates the object pose given a set of object points, their corresponding image projections, as well as camera matrix and distortion coefficients. The function attempts to finds a pose that minimizes reprojection error, i.e. the sum of squared distances between the observed projections imagePoints and the projected (using ProjectPoints2) objectPoints.

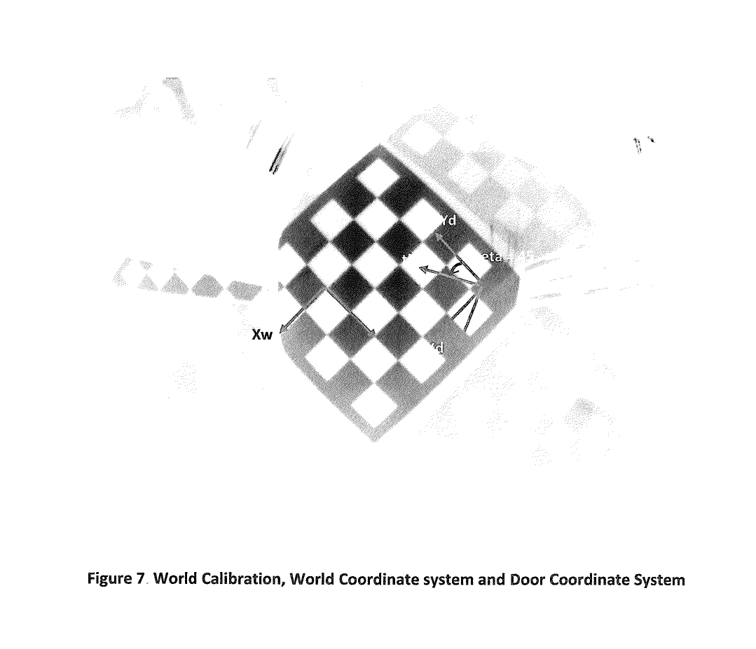

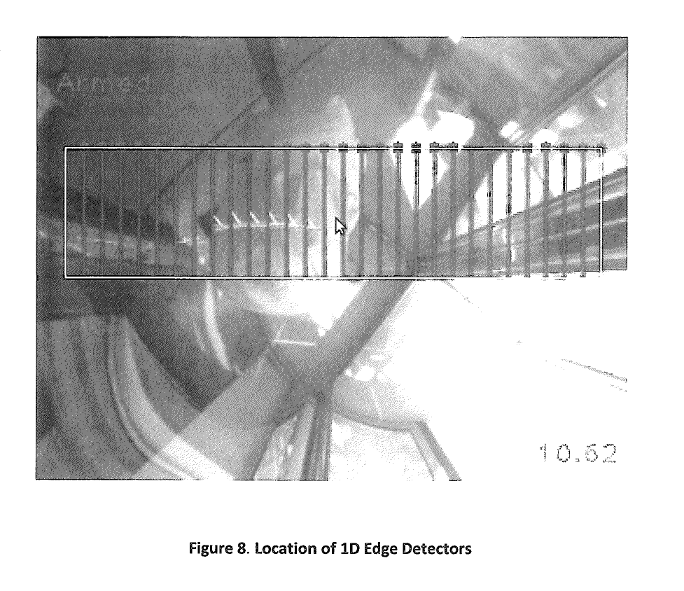

The world calibration target used is a checkerboard pattern such as shown in FIG. 7. The pattern is placed parallel to the ground (using a level) and under the camera. It thus has a known relationship to the door coordinates. Now, using the routine above, a relationship between the camera coordinates and the World coordinates can be derived.

Laser Calibration

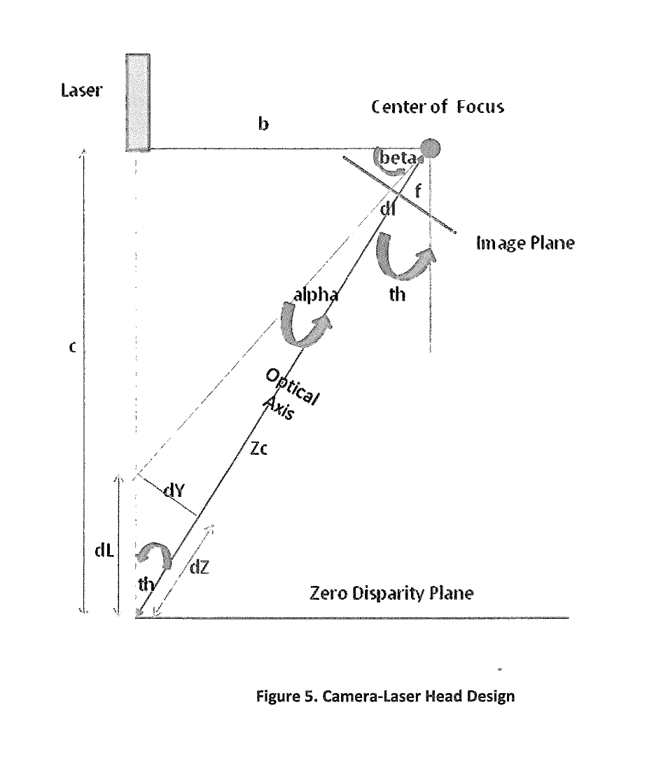

This involves finding the relationship between the Laser coordinates and the camera coordinates by the computation of the vergence angle θ shown in the FIG. 5. Some of the concepts are derived from the teachings of references [4] and [8]. Note that when the laser-camera head is assembled, the laser is rotated so that the laser line aligns with the rows of the image sensor (typically the middle row). In addition the laser is directed to be perpendicular to the ground plane, while the camera is tilted approximately 5° relative to the laser. The distance between the laser and the camera centers is approximately 3.125 inches.

Given a baseline b and the distance c of a plane parallel to the ground (c−dL) from the laser, we compute the triangulation angle β of the laser from the equation below.

$$tan ( β ) - \frac{c - dL}{b}$$

Given the y position of the laser (ypos), cy and fy, the camera calibration parameters, we can compute the camera ray angle α from the equation below

$$tan ( α ) = \frac{cy - ypos}{fy}$$

Once the angles α and β are known, the vergence angle θ is computed as:

θ=90−(α+β)

From this a standoff c, which is the intersection of the laser and the optical axis, is computed. The standoff c (from the laser) and Zc (from the camera) is computed as follows:

$$c = \frac{b}{tan ( O )}$$

$$Zc = sqrt ( b * b + c * c )$$

Any two parameters out of b, c, Zc, and θ completely specify the laser calibration. If θ and Zc are given values, the other two parameters are computed as:

b=Zc*sin(θ)

c=Zc*cos(θ)

Computation of the y position of the laser (ypos) is given as the distance of a plane from the ground or the laser. This could be useful in automatic setting of position of the 1D edge detector tools. Also, since we are given the distance of the plane from the laser (c−dL) and can compute the baseline b from the laser calibration, we can compute the laser triangulation angle β.

$$tan ( β ) - \frac{c - dL}{b}$$

Since we know β from above and the angle θ from the laser calibration, we can compute the camera ray angle α as:

α=90−θ−β

Once we know alpha we can compute ypos.

### Since

$$tan ( α ) = \frac{cy - ypos}{fy}$$

$$ypos = cy - fy * tan ( α )$$

3D Computation

Given the points (u, v) as image coordinates of the laser, what are its world coordinates Xw, Yw, Zw?

First we convert from image coordinates (u, v) to camera coordinates (X, Y, Z)
From camera calibration, we know fx, fy, cx, cy
From laser calibration we know θ, Zc
Therefore, we can compute

$${x}^{′} = \frac{( u - cx )}{fx }$$

$${y}^{′} - \frac{( u - cy )}{fy}$$

The values (x′, y′) correspond to a ray in 3D. Given Z, we can compute the 3D point in camera coordinates, where:

X=x′*Z

Y=y′*Z

A computation of Z can be obtained using the laser calibration. The value is derived from the following set of equations:

$$dI = cy - v$$

$$\frac{d I}{d Y} - \frac{fy}{Zc - dZ}$$

$$tan ( θ ) = \frac{d Y}{d Z}$$

$$\frac{d l}{d Z * tan ( θ )} = \frac{fy}{Zc - dZ}$$

$$dZ = \frac{d I * Zc}{d I + ( fy * tan ( θ ) )}$$

$$Z = Zc - dZ$$

Once the camera coordinates (X, Y, Z) are known they can be converted to world coordinates (Xw, Yw, Zw) using the world transformation matrix, which was computed during the world calibration.

APATS Wrapper Description

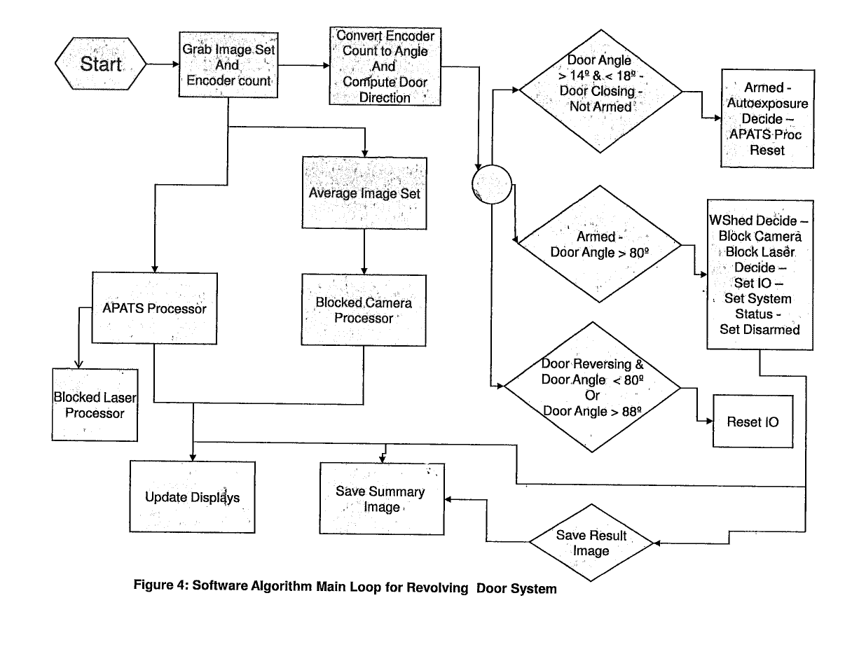

The APATS wrapper (shown in FIG. 4) combines the detection engines, state information, and decision processes. These functions are broken up into two distinct paths. The first path handles processing new image information and starts by gathering four consecutive images from the camera and organizing them based on the embedded strobe signature. The resulting image set is averaged together to improve signal-to-noise ratio before being passed to the blocked camera processor. The image set is also passed to the APATS processor which handles laser edge detection. These processors store information which is later used during the decision process. The output from the blocked camera and the APATS processor is supplied to an update display function which updates the display via the VGA frame buffer, GTK display window, or neither depending on mode of operation.

The second path handles door state information. This path starts by getting the encoder count from the USB IO interface which is obtained from the door controller. The count is converted to an angle that increases from 0° to 90° as the door closes for each quadrant. If the door is moving forward, the angle is between 14°-18°, and the system is not armed. If the system is armed, the APATS processor is reset, and the auto-exposure decision function is called. If the system is armed, and the door angle is greater than 80°, the system enters the decision process. This process calls the APATS and blocked camera decide functions, sets the IO and system status information based on those results, and sets the system to disarmed. The output display images from the decision functions are passed to the update displays and save result image functions. Finally, the USB IO is reset if the door begins reversing or if the door angle is greater than 88°.

APATS Processor

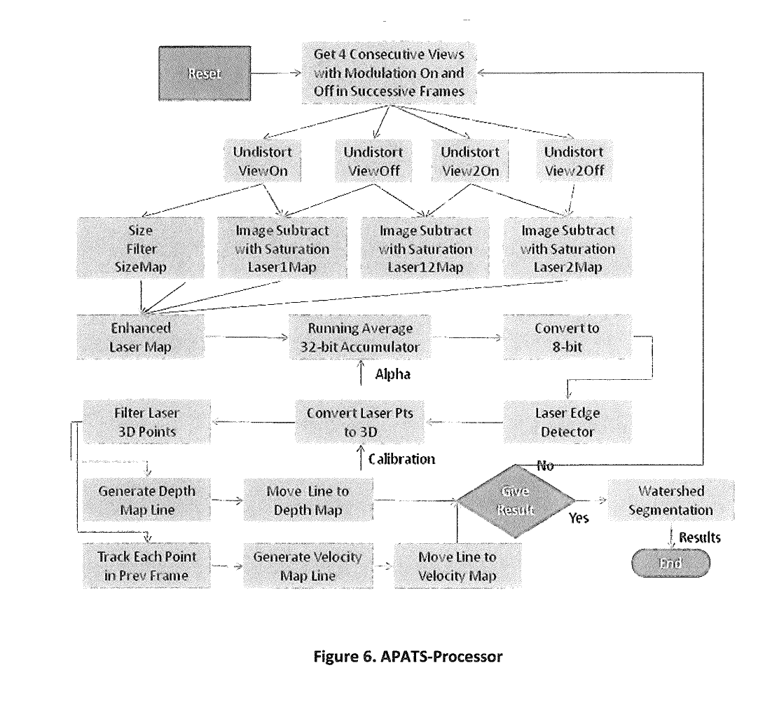

APATS processor is the computer vision tool or algorithm used for generating depth image and the velocity image is shown in FIG. 6.

The images are acquired at half-resolution, i.e., 120 frames per second. The laser is modulated so that it is “on” during the integration of one image and “off” for the integration of the next image.

The auto-exposure algorithm (described later), adjusts the exposure and the gain of the camera.

Obtain 4 consecutive images with modulation “on” and “off” in successive images.

Un-distort the 4 images using the camera calibration parameters.

Produce 3 subtraction images, each from a pair of 2 consecutive images above, by subtracting the “off” image from the “on” image. This is done to increase the signal-to-noise ratio. It is assumed that we are dealing with slow moving objects (people and their head and shoulders) relative to the high rate of acquisition (120 HZ). Therefore, the subtraction enhances the signal which is the laser (since it is “on” in one image and “off” in the other), while the rest of the background cancels itself out. The more stationary the background, the more complete is the cancellation, but objects such as people and the door leave a small amount of noise.

Note that it is possible to take just 2 consecutive images and just produce a single subtraction image with enhanced signal- to-noise. However we found that taking 4 consecutive images with 3 subtraction images produces a better result

Produce an image that is run through a morphological size filter, with a kernel that is biased to enhance horizontal lines. This involves running a series of erosions followed by dilations. The resulting image is then subtracted from the original image to produce a size filtered image. The number of erosions and dilations that run are dependent on the width of the laser line, in this case it is typically 3 pixels in width; so, and a size 3 filter is used. A result of this operation leaves lines that are 3 pixels in width and brighter than the background, which is the laser, typically laser reflections and other features in the image that are thin and bright and are moving, typically door panels. Note that clothes with white stripes will not pass through as a laser because there is no contrast on the shirt in near-IR; it is relatively blind in the color and gray-scale in the visible light spectrum.

From the 3 subtraction images and the size filtered image a laser map image is produced where each pixel in the destination image is the harmonic mean of the 4 pixels of the 4 source images.

The resulting destination pixels is further normalized by finding the maximum destination value of all pixels and computing a scaling factor of 255.0/max value, so that the contrast is maximized.

The 8-bit laser map image is then accumulated into a 32-bit floating point accumulator which is used to generate the running average over time. This function exists in OpenCV and is described below:

Cv RunningAvg(img, acc, alpha, mask=NULL)

This function calculates the weighted sum of the input images img and the accumulator acc so that acc becomes a running average of frame sequence: where alpha regulates the update speed (how fast the accumulator forgets about previous frames). That is,

acc(x,y)=(1−alpha)*acc(x,y)+alpha*img(x,y)

This is used to eliminate any moving laser like lines which are either laser reflections on the door or the door panels themselves. Since we are looking at relatively flat objects heads and shoulders, the laser is more persistent at the same spot relative to noise such as laser refection and door panels which move with the door. By taking the moving average over time, we further enhance the signal to noise ratio of the laser relative to its background. The typical alpha chosen is 0.3. The accumulator image is converted to an 8-bit image which is the source to further stages in the algorithm, it has a very high signal to noise ratio and is called the laser-enhanced image.

Laser 1D Edge Detector

A 1D edge detector (shown in FIG. 11) used in APATS processor operates as follows:

Horizontal pixels along the width of the box or rows are accumulated (called a projection) and the resultant image is a 1-dimensional 32-bit column image, with the number of pixels equal to the height of the box. The projection is done to eliminate any hot spots of white pixels, because the laser line is more likely to occur over a width of several pixels.

A convolution filter edge detection filter is run on the 1-D projection image to find locations where the brightness gradient is significant, presumably the rising and falling edges of the lasers, in addition to the other edges that may occur due to noise. The convolution filter typically used is fairly simple to compute: {−1, −1, 0, 1, 1} and in general is specified by the number of ones and number of zeros. In the above case it is 2 and 1 respectively. The number of 1s corresponds to the minimum laser width expected and the number of zeros is the type of edges expected in the system which depends on how well the image if focused and laser quality, it is expected that the edges have a ramp profile transitioning over one middle pixel (hence the use of a single 0 in the kernel). One can use more elaborate edge detection filter such as the 1st derivative of Gaussian or even 2nd derivative filters such as the Laplacian or 2nd derivate of Gaussian or Difference of Gaussian or other edge detectors in the prior-art.

Once the convolution filter is applied, the edges are detected by finding peaks and valleys (which are considered as negative peaks) in the first derivative image. A precise location of the edge can be obtained by using parabolic interpolation of the center peak pixel and the left and right neighbors of the peak. In addition the sign of the peak is also recorded for each edge.

Next the edges paired based on their polarity which is the sign of the edge (rising edge and a falling edge), strength (typically the strongest two edges correspond to the laser) and expected distance (expected laser width). The pair with the best score and above a certain threshold that satisfies the above criteria is considered to be the two edges corresponding to the laser.

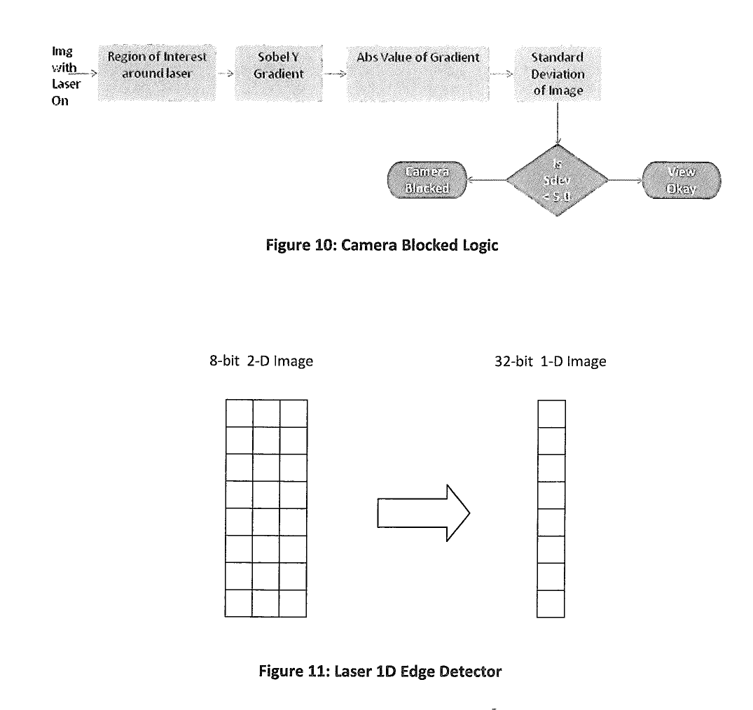

The laser edge detectors are arranged side by side as shown in FIG. 10. The width of the edge detector was empirically determined to be 8 pixels. The height and the y position of the edge detector can be set based on minimum and maximum object height to be detected. This is done by using the laser calibration function y locate that was outlined earlier.

The image position an edge (u, v) then corresponds to:

x+wd/2,(yleading+ytrailing)/2

Where x corresponds to starting x location of the detector, Wd corresponds to the width of the detector, and Y leading and Y trailing correspond to the location returned by the edge detector.

Instead of using a laser 1D edge detector one could alternatively use a Hough Line detection algorithm or a template matching algorithm to detect lines. Another option would be the use of an edge detection algorithm such as Canny or Sobel and grouping of edges of opposite polarity. Also the expected width of the laser could be made proportional to the location of the laser in the image; this is because higher objects will cause the laser position to be more displaced. Therefore, the expected width is higher at these locations, as it is closer to the camera.

Convert Laser Points to 3D and Filter Them

The points u,v are converted to Xw, Yw, Zw in world coordinates. This is done using the laser calibration routines described earlier.

Door Coordinates

Next the points are converted to door coordinates. This is also shown in FIG. 7. The world calibration plate is a checker-board that is 34 inches by 34 inches, with 5 inch squares. The relationship between the world coordinates and the door coordinates is the following:

world2Door(float Xw, float Yw, float& Xd, float &Yd, float theta)
{
float Xnew = Xw + 17;
float Ynew = −Yw + 17;
float rad = (−theta + 45)*Pl/180;
Xd = Xnew * cos(rad) + Ynew * sin(rad);
Yd = −Xnew * sin(rad) + Ynew * cos(rad);
door2World(float Xd, float Yd, float& Xw, float &Yw, float theta)
float rad = (−theta + 45)*Pl/180;
float Xnew = Xd * cos(−rad) + Yd * sin(−rad);
float Ynew = −Xd * sin(−rad) + Yd * cos(−rad);
Xw = Xnew − 17;
Yw = −(Ynew − 17);
}

Based on the 3D position of the edges in door coordinates, the edges are filtered or passed based on a volume that can be carved in a pre-determined manner. For example; edges that are too low or too close to the door, or too high, can be filtered out.

In the preferred embodiment, the radius of the 3D points are computed from the center

Rd−Xd*Xd+Yd*Yd

If the radius of the door is too close too small or too large it is filtered out (assumed to be a door feature instead of a feature on the person). In addition, if the 3D position is too low (below minimum height of interest) or too large (this is assumed to be a noisy point) it is ignored. In the latter case, the rationale is that even if the laser is on a very tall person we would still get enough of signal on the neck and shoulder to produce a relatively accurate topography. The filtered laser points are now used to generate the depth map and the tracking data which is used to fill what is called the velocity map.

Depth Map Generation

Now we are ready to generate a line or row of depth-map information. The length of the line of the depth-map corresponds to the total width of all 1d edge detectors shown earlier. If one of the 1-d edge detectors produced a laser edge point then, a strip of values corresponding to the width of that edge 1-d edge detector is written to the depth-map line. The value written is computed by the following formula, where v is the y position of the detected laser point in image coordinates, dLaserLineaAtGroundPos is a constant that is computed during calibrations and is the Y coordinate of the laser in the image plane, and dDepthConstant is another pre-computed constant multiplier to make the values in the depth map visible:

depth=(dLaserLineAtGroundPos−v)*dDepthConstant

It is possible to interpolate values from adjacent edge 1D detectors.
If the left and right edge detectors also produce edges, then:

depth=(depth+depthL+depthR)/3

or if just the left one produced an edge, then

depth=(depth+depthL)/2

or if just the right one produced an edge, then

depth=(depth+depthR)/2

Finally, if there were no neighbors the depth value is left un-interpolated.

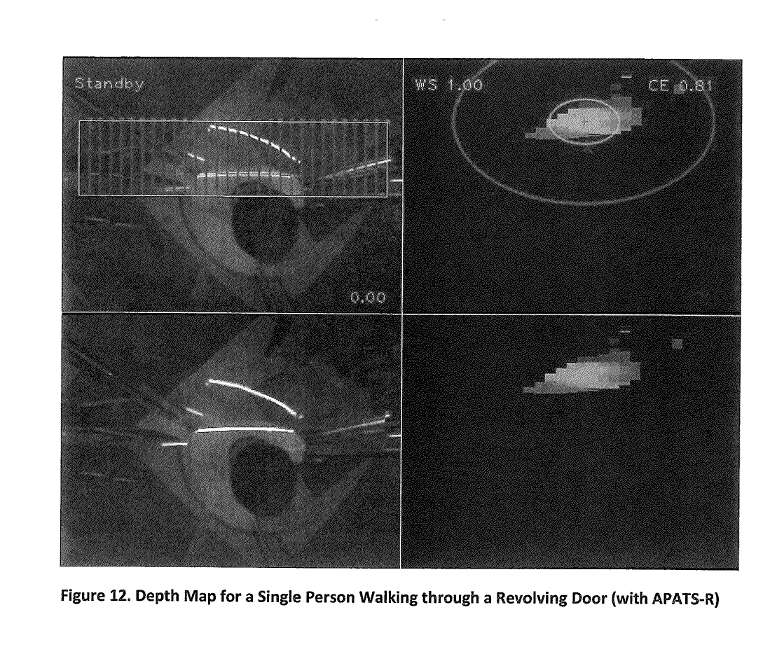

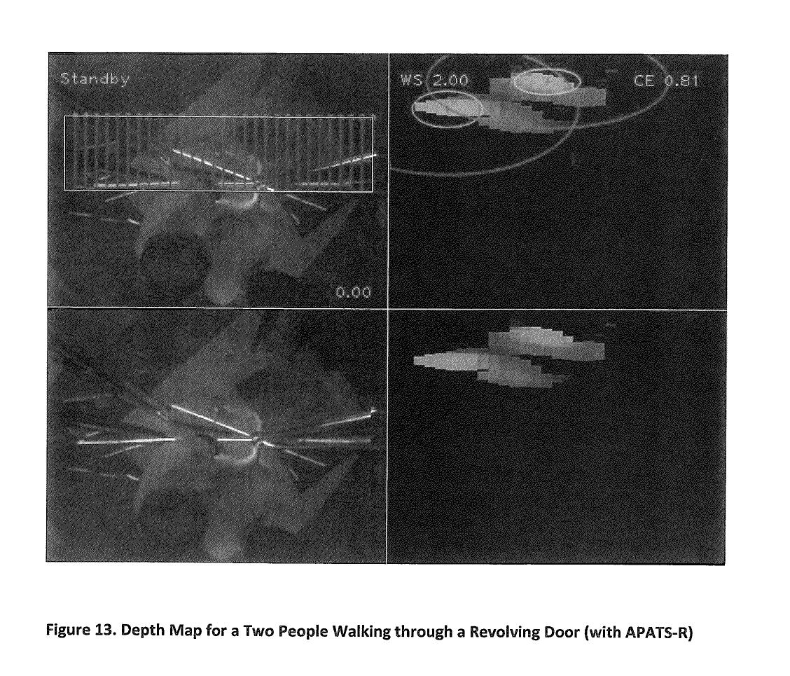

Once a line (row) of depth map information is produced it is added to a depth image which acts as a first in-first out (FIFO) buffer in time. The oldest line is the top row of the buffer and the most current information corresponds to the bottom row. If the depth map has not attained a pre-determined height, then the line is added to the bottom of the buffer, however once a pre-determined height has been attained, the top row is removed from the image and a new row is added to the bottom of the remaining image, thereby forming a new image. This acts like a rolling buffer. A typical depth map is shown in FIG. 12 for a single person and in FIG. 13 for two people.

Tracking and Velocity Map Generation

One of the reasons for specifying a filter that does not completely shut out visible light is the ability to track objects in the image, indoors and at night. This is not an issue in the presence of sunlight or outdoors because of the amount of near-IR radiation present in sunlight. Note that we specify that the lighting for the system is anything not strong enough to have the IR component wash out the laser, and preferably more diffused than direct. In the preferred embodiment of the invention, we are even successful operating with a florescent light source, since we use a near-IR filter with a fairly wide band-pass filter and increasing the exposure and the gain of the system.

Tracking is achieved by storing a previous image frame (at instance t−1, which corresponds to the previous quad of 4 images) for any one of the two off images, say the view2Off.

Given the view2Off images at instance t−1 and t, and the current position of an object at u, v, we can find the position of the object in the previous frame using a template matching algorithm. A template is created around the point u, v in the current image and using this template a search is performed on the previous image centered at u, v. The following function is used from OpenCV:

MatchTemplate(image, tempt, result, method)

The function compares a template against overlapped image regions. As it passes through the image, it compares the overlapped patches of size against a template, using the specified method, and stores the comparison results. There are many formulas for the different comparison methods one may use (denotes image, template, result). The summation is done over the template and/or the image patch:

method=CV_TM_SQDIFF

method=CV_TM_SQDIFF_NORMED

method=CV_TM_CCORR

method=CV_TM_CCORR_NORMED

method=CV_TM_CCOEF

method=CV_TM_CCOEFF_NORMED

After the function finishes the comparison, the best matches can be found as global minimums (CV_TM_SQDIFF) or maximums (CV_TM_CCORR and CV_TM_CCOEFF) using the MinMaxLoc function. In the case of a color image, template summation in the numerator and each sum in the denominator are done over all of the channels (and separate mean values are used for each channel).

In the preferred embodiment we use CV_TM_CCOR_NORMED and finding the maximums.

$$R ( x , y ) = \frac{{\sum }_{{x}^{′} , {y}^{′}}^{ } ( T ( {x}^{′} , {y}^{′} ) \cdot {I}^{′} ( x + {x}^{′} , y + {y}^{′} ) )}{\sqrt{{\sum }_{{x}^{′} , {y}^{′}}^{ } {T ( {x}^{′} , {y}^{′} )}^{2} \cdot {\sum }_{{x}^{′} , {y}^{′}}^{ } {I ( x + {x}^{′} , y + {y}^{′} )}^{2}}}$$

Once the location of the template is found in the previous image, the trajectory vector can be computed by finding the vector between the current frame position and the prey frame position. The y component of the vector is assumed to be proportional to the velocity. So like the depth image line, a velocity image line is added.

velocity=(curpos_{y}−prevpos_{y})*16+128

These velocities could be interpolated in a similar fashion as the depth interpolation using adjacent velocities. The velocity line (row) is added to a velocity image buffer which just like the depth map is a rolling FIFO buffer.

Watershed Processing

The Watershed algorithm is based on the algorithm described in [9] and is listed below.

Watershed_Algorithm( )
{

Subsample depthMapImg and Fill holes
Given this subsampled height image dHeightImg
Create images dVisitImg, dWshedImg with same dimensions as
dHeightImg
dVisit Img is used to keep track of pixels that have already been

visited

dWshedImg is used to keep track of the labels assigned by the
dWshedImg ← 0
label ← 1
While (1)
{
Find max_val (and max_pt the x, y location) in Wshed that has not

been already assigned a label.

If (max_val < height_threshold)

We are done so we can break out of the loop

dVisitImg ← 0
Create new object with new label
object.peak_val = max_val;
object.peak_pt = max_pt;
object.label = label;
Push max_pt into a FIFO queue of points
While (fifo is not empty)
{
pt ← Pop the FifoElement from the fifo
// Append the label
Val = Wshed(pt.x, pt.y);

Wshed(pt.x, pt.y) = Val | label;

Get Neighbors of pt
// Add neighbors to fifo if the topography is flat or going down
For each Neighbor

If (the neighbor has not been visited), and
If (the neighbor height > height_thresh), and
If (the neighbor height <= current pixel height),
push the new pt on to the fifo.

Mark the neighbor point has been visited.
}
}

Next, compute the weighted center of mass (weighted by the height) for the various labeled objects, and reassign watershed pixels (pixels with multiple labels to a single label based on object with closest center of mass).

Recompute the weighted center of mass, area and volume (cumulative height) and weighted average velocity of the objects

Filter based on minimum area, minimum volume, velocity or any combination.

Scoring and Event Generation

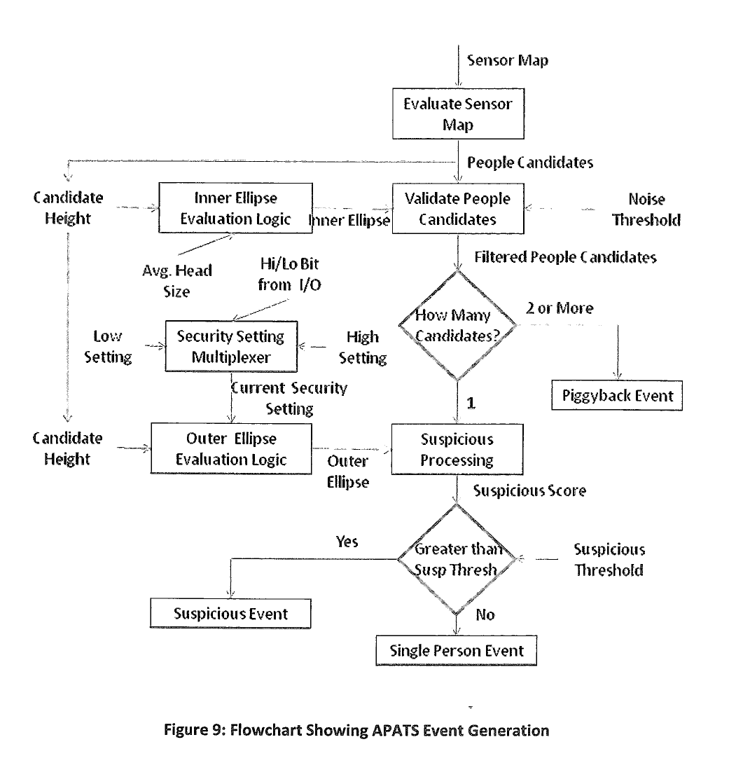

FIG. 9 shows the decision making logic for APATS for generating events.
1) Analyze the sensor map topography for generating potential people candidates.
2) Next the people candidates are validated by first constructing an ellipse (called the inner ellipse) from the average head size of a person, height of the candidate and the pixel velocity of the candidate computed from the velocity map. This ellipse is shown in FIG. 12 and FIG. 13. Next the percentage of the ellipse occupied by the sensor map (head of the person candidate) is computed. If it is greater than the noise threshold (which is a number from 0 to 100), the person candidate is said to be validated otherwise it is filtered out.
3) Next we check if the number of filtered people candidates. If there are 2 or more candidates a piggyback event is generated.
4) If there is just 1 candidate produced then further processing is performed to generate single person and suspicious event.
5) The current security setting of the system is either the either the low setting or the high setting based on the security bit of the I/O. The low setting and the high setting parameters are programmable using the Graphical User Interface.
6) Based on the current security setting, the height of the people candidate, pixel velocity of the candidate computed from the velocity map, an outer ellipse is computed. This outer ellipse has a maximum size that is 5 times the size of the inner ellipse (0) to a minimum size of 1 time the size of the inner ellipse (1) that was compute earlier. These extremes can be changed and are set empirically. This is shown in FIG. 12 and FIG. 13.
7) The outer ellipse is applied against the sensor map and is intended to encapsulate the entire body of the person. The percentage of the pixels that fall outside this outside ellipse is called the suspicious score and is compared against the suspicious threshold (which varies from 0 to 100).
8) If the suspicious score is greater than suspicious threshold then a suspicious event is generated otherwise a single person event is generated.
9) There is some special processing done for Boxes which is not shown in the flow chart. If any person candidate height is below the height of 0.5 m then it is assumed that it is a box or a crouching person and an output of suspicious event is generated.

Auto-Exposure Algorithm

The following is the auto-exposure algorithm used in the system:
Set the gain to 0 DB
Set camera on a standard auto-exposure algorithm and allow it to settle
Set a fixed exposure based on last sample exposure, for the entire compartment
Critical pieces are when to sample the auto-exposure which is typically when the door is between 80 and 90 degrees.

Also since we are interested in best signal to noise, that is the laser relative to the background, we optionally set the region of interest to run the auto-exposure algorithm on, preferably the region where the laser is expected over a range of depths. If the system is expected to operate in heavy sunlight, a high dynamic range camera or mode could be used. Another option to improve dynamic range is to turn on the Gamma mode for the camera.

Camera-Block Algorithm

This algorithm shown in FIG. 11 is used to check if the camera is blocked or is no longer functioning and can be particularly important in security applications of this invention. This relies on ensuring that either the door or the laser is visible in a camera image by running tools to detect strong vertical gradients (since the laser is setup to be horizontal in the camera field of view). This can be done by detecting a Sobel-Y gradient image followed by computing its standard deviation. A large standard deviation indicates the presence of the laser and the camera (or the laser) not being blocked. Typically this is measured over several consecutive images before making a decision if the camera is blocked or not.

Laser-Block Algorithm

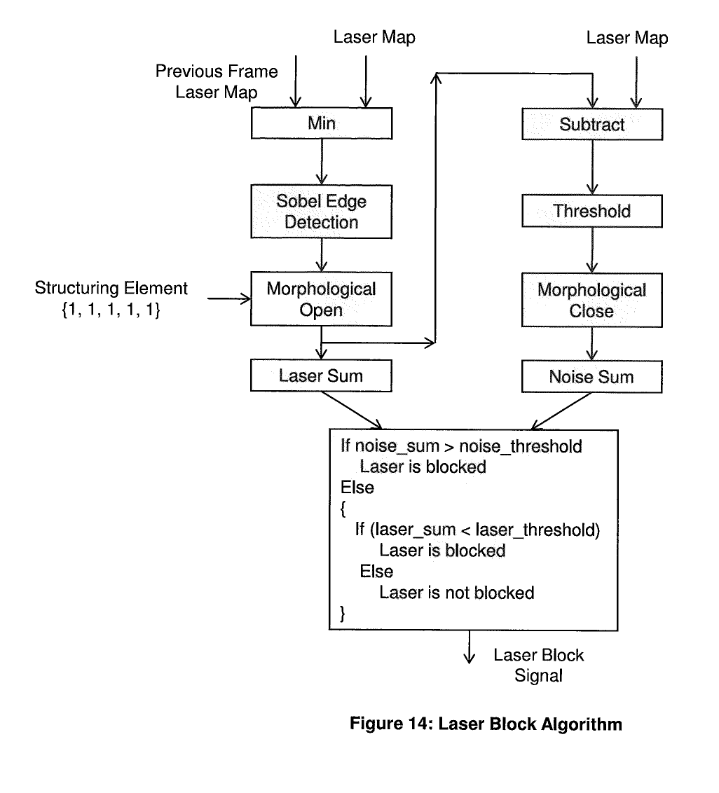

This algorithm shown in FIG. 14 is used to check if the laser is blocked or is no longer functioning and can be particularly important in security applications of this invention. This relies on ensuring that the laser is visible in a camera image by summing the pixels on an enhanced laser map. The tool chain is running an edge detector followed by a Morphological opening to remove noise. A small sum indicates the absence of the laser. However, there may be situations when a target is too close to the laser, in such cases the enhanced laser map is extremely noisy, to guard from such a situation, the noise level is first checked to ensure that it is within acceptable limits. Typically the laser sum is measured over several consecutive images before making a decision if the laser is blocked or not. One optional way to enhance the reflection of the laser and increase the laser sum (signal to noise ratio) is the use of a retro-reflective tape attached to the door frame or guard. These tapes are available in multiple colors and can blend into the background to the naked eye, but the laser is strongly reflected by them to the camera, thereby appearing bright.

In view of the foregoing, it will be seen that the several objects and advantages of the present invention have been achieved and other advantageous results have been obtained.

### APPENDIX A

### References

[1] Method and Apparatus for Monitoring a passageway using 3D images, U.S. Pat. No. 7,397,929
[2] Method and System for Enhanced Portal Security Through Stereoscopy, U.S. Pat. No. 7,623,674
[3] U.S. Patent Application No. U.S. Pat. No. 7,042,492 to Spinelli
[4] Computer Vision, Three-Dimensional Data from Images by Reinhard Klette, Karsten Schluns, Andreas Koschan, Chapter 9, Structured Lighting, Pages 347-374.
[5] Learning OpenCV: Computer Vision with the OpenCV Library, Gary Bradski & Adrian Kaehler, http://opencv.willowgarage.com
[6] A versatile Camera Calibration Technique for high-accuracy 3D Machine Vision Metrology using off-the-shelf TV Camera and Lenses, “IEEE Robotics & Automation”, Vol 3. No. 4, PP 323-344 by Roger Y. Tsai.
[7] A Flexible New Technique for Camera Calibration, “Technical report MSR-TR-98-71”, Microsoft Research, Microsoft Corporation, pp 1-22 (Mar. 25, 1999), by Z. Zhang
[8] Non-Contact Surface Geometry Measurement Techniques, Gareth Bradshaw, Image Synthesis Group, Trinity College Dublin, Ireland (1998/1999), http://www.scss.tcd.ie/publications/tech-reports/reports.99/TCD-CS-1999-46.pdf
[9] L. Vincent, P. Soille, “Watersheds in Digital Spaces: An Efficient Algorithm Based on Immersion Simulations,” IEEE Transactions on Pattern Analysis and Machine Intelligence, vol. 13, no. 6, pp. 583-598, June, 1991.
[10] (WO/2003/088157) TAILGATING AND REVERSE ENTRY DETECTION, ALARM, RECORDING AND PREVENTION USING MACHINE VISION
[11] Method and apparatus for detecting objects using structured light patterns, WO/2004/114243.
[12] Anti-piggybacking: sensor system for security door to detect two individuals in one compartment, U.S. Pat. No. 5,201,906
[13] Security Door USPTO Patent Application 20060086894
[14] Stereo Door Sensor U.S. Pat. No. 7,400,744.

1. A system for monitoring a portal or passageway and objects moving through it, comprising:
an imaging means and a light source, the imaging means and light source together creating a three-dimensional image of a scene in the portal or passageway which defines a target volume through which movement of an object is tracked by the imaging means; and,
a processor to which information from the imaging means relating to movement of objects through the target volume is supplied, the processor executing an algorithm using the supplied information so to classify the movement through the portal or passageway and provide an indication thereof.

2. The system of claim 1 in which the imaging means is a camera and the light source is a structured light source calibrated to enable three-dimensional computation of the points of the light source visible to the camera and which corresponds to the position of a surface of the object located within or moving through the target volume.

3. The system of claim 2 in which the camera is a monocular camera and the structured light source is a laser.

4. The system of claim 2 in which the processor computes the co-ordinates of the points of the structured light source visible in the camera image, and uses the results to determine the height and depth of the object being tracked.

5. The system of claim 4 in which the processor further:
concatenates the height and depth of the object over time so to form consolidated two-dimensional topography images of the object as it passes through a plane established by the light source;
analyzes the images and segments them into objects of interest; and,
classifies the results.

6. The system of claim 5 in which the processor further:
computes the velocity and trajectory of the object's surface that corresponds to the points of the structured light source visible in the camera image by using template matching of a region of interest over multiple images captured during those times in which the light source is off;
generates velocity images and trajectory images;
concatenates the velocity images and trajectory images to form consolidated two-dimensional images; and,
using the classification from the segmented image, computes the velocity and trajectory of the object as it passes through the target volume.

7. The system of claim 6 in which the processor classifies certain types of movement as an unauthorized movement event using one or more of the position, count, shape, size, volume, color, trajectory, and velocity information obtained, the objects being people and the event being used for the purpose of anti-piggybacking and anti-tailgating through a passageway which includes revolving doors, swinging doors, sliding doors, mantraps, and other portals.

8. The system of claim 7 in which the processor counts the number of people going through a hallway, portal or any virtual plane perpendicular to the ground plane.

9. The system of claim 7 in which the processor detects the movement of people or thrown objects in a wrong-way direction through the portal or passageway.

10. The system of claim 3 in which the laser is a line laser that forms a laser plane in three-dimensions, the laser operating in the near-IR range and being aligned so it is substantially horizontal in a camera image, and substantially perpendicular to the ground.

11. The system of claim 10 in which the laser is a monochromatic light source and the camera uses a bandpass filter tuned to pass wavelengths at, or adjacent to, the wavelength of the laser.

12. The system of claim 11 in which the laser is pulsed “on” and “off” and images are captured when the laser is both “on” and “off”.

13. The system of claim 12 in which the three-dimensional data points are filtered based upon a statically generated target volume and with the remaining three-dimensional data points being used to generate the depth and height information for an image.

14. The system of claim 13 in which the three-dimensional data points are filtered based upon a dynamically generated target volume and with the remaining three-dimensional data points being used to generate the depth and height information for an image.

15. The system of claim 3 utilizing a world coordinate system calibrated relative to the location of the camera and laser.

16. The system of claim 15 in which the target volume is specified relative to a portal coordinate system that is calibrated relative to the world coordinate system.

17. The system of claim 11 in which the signal-to-noise ratio of the laser relative to a background is increased by one or more of:
running an auto-exposure algorithm focused on areas where the laser is expected in the image;
subtracting images made when the laser is “off” from images made when the laser is “on”;
detecting bright lines of an expected width within an image;
combining elements of the respective images using a harmonic mean of the constituent images; and,
accumulating and filtering the images, over time, to eliminate reflections within the images.

18. The system of claim 3 further including a plurality of one-dimensional edge detectors to detect points of the structured light source visible in the camera image.

19. The system of claim 7 which, when used with a revolving door, uses encoder signals to start and stop the processor processing, and generate an event indication.

20. The system of claim 19 in which the camera and laser are installed in a head which is mounted such that the plane of the light emitted by the laser is along an X-axis position of the door which is at 45° at the portal entrance.

21. The system of claim 4 in which the generated height image topography is segmented using a Watershed Segmentation Algorithm.

22. The system of claim 4 further including a camera auto-exposure algorithm which is executed by the processor on a region of interest in the image, the algorithm computing a range of depths an object is expected to have and consequently a range of image positions of the laser.

23. The system of claim 4 in which the camera or laser may be blocked, camera blockage being detected by computing vertical gradients in a region of interest in images produced by the camera and their standard deviations, and laser blockage being detected by summing the number of pixels in a laser enhanced image after minimizing the effect of noise using morphology, detection of camera or laser blockage being performed to ensure that either the door or the laser is always visible.

24. The system of claim 5 in which inner and outer ellipses are computed by the processor using the height of the object and its velocity, the processor further executing a scoring algorithm on the ellipses with the inside ellipse being scored to validate the presence of an object and the outer ellipse being scored to determine if an event should be classified as a suspicious event.

25. The system of claim 5 further including a retro-reflective target positioned so to be in the background of an image produced by the camera, for detection of a reflection of the laser light in the camera image indicating that the laser and camera are operating normally.
